(19) United States
(12) Patent Application Publication
(10) Pub. No.: US 2004/0195408 A1
(43) Pub. Date: Oct. 7, 2004

(54) Tire assembly support frame for irrigation systems

(76) Inventor: Donald Starr, Summerville, OR (US)

Correspondence Address: BRADLEY M GANZ, PC, P O BOX 10105, PORTLAND, OR, 97296

(21) Appl. No.: 10/775,669

(22) Filed: Feb. 9, 2004

Related U.S. Application Data
(60) Provisional application No. 60/446,057, filed on Feb. 7, 2003.

(51) Int. Cl. B05B 3/00

(52) U.S. Cl. 239/728

(57) ABSTRACT

The present invention provides support frame for a tire assembly for irrigation systems that prevents the formation of ruts caused by repeated travel along a path by tires of a mobile vehicle or structure. The support frame includes a force transfer member connected between the support frame and the irrigation tower structure for transferring forces generated by the tire assembly to the tower structure. The support frame includes plural adjustable mounting features to accommodate a retro fit to a variety of existing units. The support frame further includes an adjustable compensation spring to adjust to forces applied to the support frame caused by uneven terrain. The support frame is adapted for use with corner sweeping units.

This invention claims the benefit of co-pending U.S. Provisional Application No. 60/446,057, entitled “Tire Assembly Support Frame For Irrigation Systems”, filed Feb. 7, 2003, the entire disclosure of which is hereby incorporated by reference as if set forth in its entirety for all purposes.

### TECHNICAL FIELD

This invention relates to irrigation systems and in particular to a support frame for a tire assembly for mobile irrigation structures.

### BACKGROUND OF THE INVENTION

Irrigation systems are commonly used in agricultural operations such as, for example, large scale commercial farms. One common type of such a system is a center-pivot irrigation system which typically employs an elongate boom that is connected at one end to a center pivot which acts as a water source for the boom. Typically, the boom is comprised of a plurality of pipes connected together extending away from the center pivot with sprinklers or other watering devices located along the length of the boom to spray water across the soil. The boom is elevated and supported by a number of mobile towers with wheels for transport across the ground. One of the towers acts as a drive tower so that the boom travels in wide circles about the center pivot. Some of the center pivot systems employ a corner sweep unit for systems that are located near the corner of a plot of land. The corner sweep unit is located at the end of the boom opposite the center pivot. The corner sweep unit pivots about it's own axis as the corner sweep unit approaches the corner of the property as the boom rotates. Corner sweep units maximize the use of irrigation water in tight corners to ensure irrigation of the most amount of soil.

Another common type of irrigation equipment is known as a linear system that typically uses the same type of equipment described above but that travels along a straight path instead of a circular path.

The irrigation systems described above are typically repeatedly driven along their paths for a period of time to adequately irrigate the land and create very wet soil conditions over which the irrigation equipment must necessarily travel. Most current irrigation equipment systems employ tires that have a tread such as, for example, a tractor tread tire on the towers to move the system across the ground. One problem with such tires is that the tread in the tires directs water to the center of the path along which the tire travels causing further saturation of the soil creating a very muddy and soggy travel path. Because the irrigation systems are driven over the same path for long periods of time ruts eventually develop along the path. The weight of the irrigation equipment along with the soggy soil along the travel path contributes to the formation of ruts. Depending on the type of soil and how long the irrigation system travels over the same path the ruts can become several feet deep. As an example, ruts as deep as five or six feet deep are known to have been formed.

These ruts cause several problems. One problem is that the tires of the tower may become stuck so that the tower is unable to continue along the path. With very deep ruts, parts of the tower itself may engage the ground and may become stuck. For example, the towers form a frame that supports the boom and the tires. The frame may include cross struts that extend between front and back members of the frame located several feet above the ground surface. Some ruts are so deep that the cross struts are at ground level and drag along the ground surface and may become stuck. Parts of the irrigation equipment may experience damage or failure. Furthermore, a tractor or other large vehicle must be utilized to pull the tower from its stuck position. This increases the time and expense of irrigation.

Another problem caused by ruts is that they can damage other agricultural vehicles that travel across the field. For example, some commercial farm vehicles such as fertilizers typically travel across a crop field at a speed of about 15 mph. Some of these vehicles use a boom of between 80-100 ft. long to disperse fertilizer across the crop field. Other vehicles or equipment such as hay balers and harvesters carry heavy loads. Traveling across ruts at such speeds puts great stress on the vehicles and they may experience damage. Significant damage may occur with very deep ruts. In order to avoid damage the vehicles must slow down each time a rut is encountered. Since the vehicles are unable to travel at a constant speed production time and labor costs are increased.

Yet another problem caused by ruts is erosion. Erosion is a problem encountered with many agricultural endeavors. Ruts magnify the erosion problem by providing a channel in which the irrigation water or rain water washes away topsoil. This is especially problematic on land that slopes or on farmed land located on hillsides. In some instances the washed-away soil may be recovered and hauled back to its original location. If the washed-away soil is not recoverable new soil must then be brought in and distributed over the eroded land. In addition to damage to the land such erosion causes increased expense for soil recovery and/or replacement.

Some attempts to solve the problem with ruts include filling the ruts with straw, wood chips, compost, gravel, concrete or debris. This attempt has not proved to be acceptable because of land pollution and contamination issues. Successive land owners may experience damage to some equipment and may be required at great expense to clean up and remove the fill material. If contamination of the soil is an issue additional costs must be incurred to remove such contaminants.

Other attempts to fill the ruts include the use of commercially available clotting pellets or other clumping material that hardens when wet. However, such products have proved to be inconsistently effective. Additionally, these products must be purchased every time a rut is formed which increases costs and requires continued maintenance.

One prior art device that attempts to prevent formation of ruts utilizes a ground engaging track for the tower wheels. The track comprises flat plates or sections that are hinged together around the tire. The device has side walls that extend down the sides of the tire. The problem with such a device is that the hinges wear out which may cause damage and require repair or replacement of the device. The side walls of the device also pinch the sides of the tires causing wear and damage to the tires. Additionally, if the device encounters a rocky patch in the soil the device may get stuck or stall causing the tire to spin inside the track. Furthermore, such a device experiences vibration which loosens lug nuts on wheels and causes noise.

Other attempts to prevent ruts from forming include the use of steel wheels. However, such wheels are very heavy and place a great deal of stress on the axle and/or gear box of the tower drive mechanism. Additionally, such steel wheels require a vehicle such as, for example, a front end loader to attach the steel wheel to the tower.

### SUMMARY OF THE INVENTION

The present invention provides a device for irrigation systems that prevents the formation of ruts caused by repeated travel along a path by tires of a mobile vehicle or structure. The irrigation system includes an elongate boom connected at one end to a center pivot that acts as a water source for the boom. The boom includes a plurality of pipes connected together to extend away from the center pivot with sprinklers located along the length of the boom to spray water across the soil. The boom is elevated and supported by a number of mobile towers each of which has a tire assembly for transporting the tower and, thus, the boom across the ground in wide circles about the center pivot.

Each tire assembly includes dual tires mounted on an axle with a flexible belt member wrapped around the outer periphery of the two tires. The flexible belt member is preferably adapted to be wrapped around the dual tires so that an inner surface of the flexible belt member engages the outer periphery of the tires and an outer surface of the flexible belt member engages the ground. The flexible belt member includes opposed ends and means to secure the opposed ends together when mounted on the dual tires.

The flexible belt member may include a plurality of spaced apart cleats located on the outer surface of the flexible belt member. The cleats provide traction as the tower moves along the path. The cleats are preferably spaced apart a distance to allow the flexible belt member to engage the ground and provide a ground engaging surface to substantially evenly distribute the weight of the tower structure across the ground to reduce ground compaction. Furthermore, the cleats direct water away from the center of the travel path to the outer sides thereof.

The present invention also provides a dual tire assembly in which one tire is inflated to inflation pressure that is greater than that of the other tire. Inflating one tire to a pressure greater than the other tire prevents too much pressure or leverage from being applied to the tire assembly drive mechanism. Preferably, the inner tire or tire located toward the center pivot is inflated to about twice the pressure of the outside tire.

The present invention further provides a tire assembly support frame that supports the tire assembly. The support frame substantially removes forces carried by the outer tire that would otherwise be transferred to the gear box possibly causing damage. The support frame may be connected to and supported by the tower structure on one side and is connected to the outer tire through an extended axle. The support frame includes a force transfer member connected between the support frame and the tower structure for transferring forces generated by the tire assembly to the tower structure. The support frame includes a plurality of adjustable mounting features to accommodate retrofitting to a variety of existing units. One or more compensating springs may be incorporated into the support frame to adjust to varying pressure applied to the support frame by uneven terrain. The support frame, including at least the features mentioned above, may also be adapted for use with corner sweep units.

The invention is particularly effective in wet or loose soil environments created by irrigation systems and/or farming activities for large or commercial farms. Although the invention is described as being used primarily with center pivot irrigation systems, it is contemplated that the present invention not be limited to center pivot irrigation systems but may also be used with other irrigation systems such as, for example, linear irrigation systems and other mobile structures in which the formation of ruts in the ground is a problem.

The foregoing is not intended to be an exhaustive list of embodiments and features of the present invention. Persons skilled in the art are capable of appreciating other embodiments and features from the following detailed description in conjunction with the drawings.

### BRIEF DESCRIPTION OF THE DRAWINGS

FIG. 1 is a top plan view of a simplified center pivot irrigation system utilizing mobile support structures to support an elevated boom.

FIG. 2 is a partial plan view of a mobile support structure with a tire assembly of the present invention.

FIG. 3 is a front view of the tire assembly of the present invention.

FIG. 4 is a side view of the tire assembly of the present invention.

FIG. 5 is a side view of the flexible belt in a flat condition.

FIG. 6 is a sectional view along lines 6-6 in FIG. 7 of a support frame for the tire assembly.

FIG. 7 is a front view of the support frame with the tire assembly shown in phantom.

FIG. 8 is a side view of the support frame with the tire assembly and flexible belt.

FIG. 9 is an enlarged partial front view of the mounting of the support frame to the tower structure.

FIG. 10 is a side view of the mounting shown in FIG. 9.

FIG. 11 is a front view of a support frame for a corner unit of an irrigation system.

FIG. 12 is a side view of the support frame as shown in FIG. 11.

FIG. 13 is a partial view showing the connection between the support assembly and the horizontal members of FIGS. 11 and 12

FIG. 14 is a front view showing another embodiment of the corner sweeping unit support frame.

FIG. 15 is a partial view showing the connection between the support assembly and the horizontal members of FIG. 14.

### DETAILED DESCRIPTION

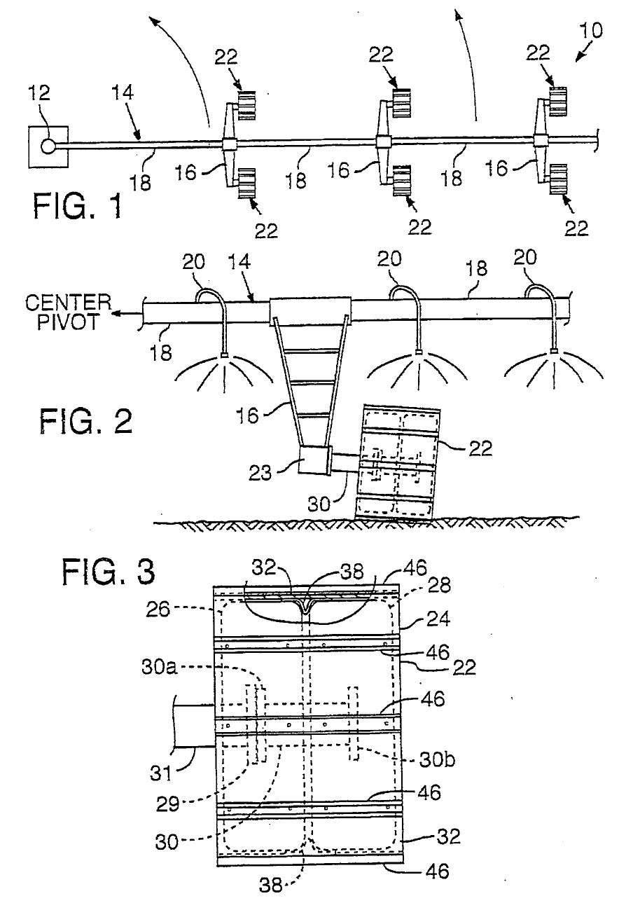

Referring now to FIGS. 1 and 2, a center pivot irrigation system 10 is shown in accordance with the present invention wherein the system 10 is adapted to rotate about a center pivot 12 that serves as a water supply for an elevated boom 14. Boom 14 is supported on a plurality of mobile support structures or towers 16. Although these figures illustrate a center pivot irrigation system the present invention is not intended to be limited to center pivot irrigation systems. Additionally, although only one boom 14 and three mobile towers 16 are shown the present invention is not intended to be limited to the number of booms or mobile tower structures. The number of towers depends of the length of the boom which is dependent on the size of the area of land to be irrigated. For example, the span between mobile towers 16 is typically between about 130 to 140 ft. However, this length may vary.

As seen in FIGS. 1 and 2, centrally located pivot structure 12 serves as a water supply to boom 14. Boom 14 comprises a plurality of pipes 18 connected end-to-end with sprinklers 20 spaced along the length of boom 14. Boom 14 is supported by mobile towers 16 that have ground engaging elements 22 to propel boom 14 along a travel path about central pivot 12. Preferably, each tower 16 includes front and rear ground engaging elements 22. Towers 16 are self-propelled by ground engaging means 22 that are driven through a gear box drive mechanism 23 in a manner known to those skilled in the art.

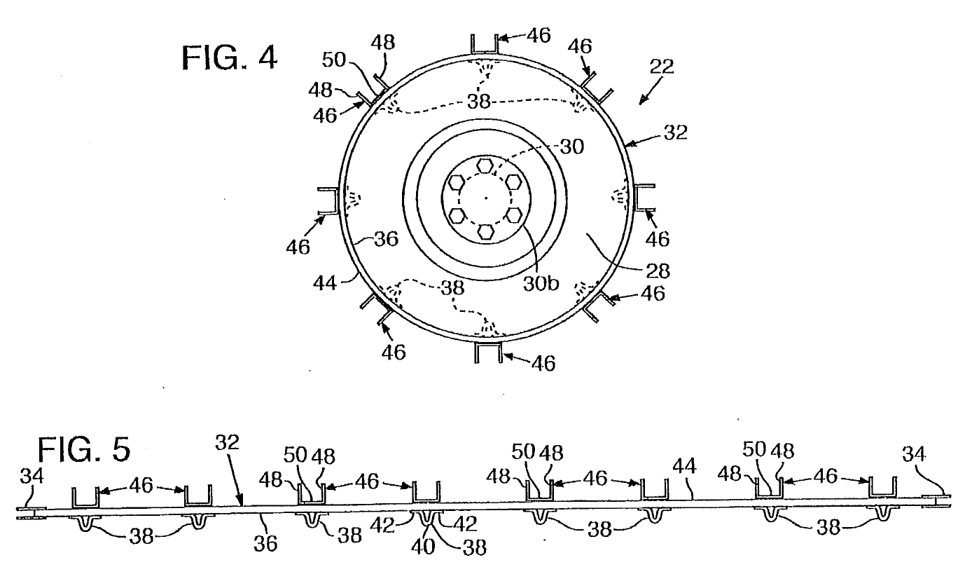

As seen more clearly in FIGS. 2-4, each ground engaging means 22 is shown as comprising a tire assembly 24 comprising dual tires 26 and 28 mounted for rotation on a hub 30. Hub 30 includes flanges 30a and 30b on each end having bolt holes matching the bolt hole configuration on the wheels as best seen in FIG. 4. One of the flanges 30a is connected to a flange 29 on an axle 31 from gearbox 23 by bolts or any other suitable connection. Hub 30 acts as an extension from gearbox 23 to accommodate mounting of dual tires 26 and 28. FIG. 2 shows that tire assembly 24 is canted or mounted on an angle to a vertical axis. This is done to prevent the application of too much force or pressure on the axle 31 and/or gear box 23 as system 10 is driven around its travel path. For example, tires that are mounted normal to the boom 14 and supported on an axle positioned normal to tower 16 have the tendency to follow a straight path. However, the tires are forced from a straight path by the center pivot structure so that the tires travel in a circular path. This puts a great deal of stress on axle 31 and/or gear box 23 as well as causing wear on the tires. Tire assembly 24 of the present invention is capable of having a canted mounting by inflating one of the tires to a pressure of about twice that of the other tire. For example, the tire closest to the center pivot, referred to as the inner tire as seen most clearly as tire 26 in FIG. 3, may have an inflation pressure of about 28-30 psi. The other tire, referred to as the outer tire as seen most clearly as tire 28 in FIG. 3, may have an inflation pressure of about 10-12 psi. Thus, the tires 26 and 28 counteract the force from center pivot 12 tending to pull or force tires 26 and 28 toward center pivot 12.

Tire assembly 24 includes a flexible member or belt 32 wrapped around the outside of tires 26 and 28. Belt 32 is made of a flexible material such as, for example, rubber and has a substantially flat shape before mounting on tires 26 and 28 as seen in FIG. 5. Belt 32 has a length and a width with opposed ends having a coupler 34 to connect the opposed ends of belt 32. One example of such a coupler 34 is belt lacing that may be interwoven and secured with the opposed ends of belt 32 when it is wrapped around tires 26 and 28. However, although only belt lacing is described as one type of coupler it is within the scope of this invention that any suitable coupler for connecting the opposed ends of belt 32 may be utilized. In order to mount belt 32 onto tires 26 and 28 they may be deflated to an inflation pressure less than that in use to facilitate mounting of belt 32 around the outer periphery of tires 26 and 28. After belt 32 is mounted on tires 26 and 28 they are inflated to their respective inflation pressures as described above. The length and width of belt 32 may vary according to the size of tires used. For example, with 14.9×24 tires, belt 32 may have a length of about 156 inches and a width of about 30 inches. As another example, for 11.2×24 tires, belt 32 may have a length of about 139 inches with a width of about 24 inches.

Belt 32 has an inner surface 36 that lies adjacent to the outer surface of tires 26 and 28 when mounted thereon. At least one and preferably a plurality of center guides 38 are mounted to inner surface 36 of belt 32. Each center guide 38 is preferably a formed metal piece having a central protrusion 40 with flat ends 42 for connection to inner surface 36 of belt 32 by a suitable connector, such as, for example, with a strong adhesive or a fastener pin. Center guides 38 help keep belt 32 in place during use.

Outer surface 44 of belt 32 includes a plurality of cleat elements 46 that substantially extend across the width of belt 32 as best seen in FIG. 3. Cleat elements 46 may be in the form of channel iron having side walls 48 extending outwardly from a base 50. Base 50 may be secured to outer surface 44 of belt 32 by any suitable connector such as, for example, fastener pins, so that side walls 48 engage the ground to provide traction as tire assembly 24 moves along the travel path. Side walls 48 further act to direct water to the outer sides of tire assembly 24 and, thus, away from the center of the travel path. Cleat elements 46 are spaced along the length of belt 32 in a manner to allow outer surface 44 to engage the ground. In one preferred example, cleat elements 46 are spaced about 10 inches apart. Although cleat elements 46 are described as channel iron other types of cleat elements are envisioned by this invention for channeling water away from the center of the travel path, as well as for traction.

Tire assembly 24 of the present invention reduces soil compaction by providing a ground engaging surface area 44 of belt 32 to distribute the weight of the irrigation equipment. As one example, some prior center pivot irrigation systems can produce a force on the ground of about 86 pounds per square inch depending on the size of the tire. Using tires of comparable size, tire assembly 24 of the present invention produces a force of only about 26 pounds per square inch on the ground. Thus, the reduction of soil compaction substantially reduces the formation of ruts in the ground. Additionally, directing water away from the center of the travel path by cleat elements 46 further reduces the formation of ruts in the ground.

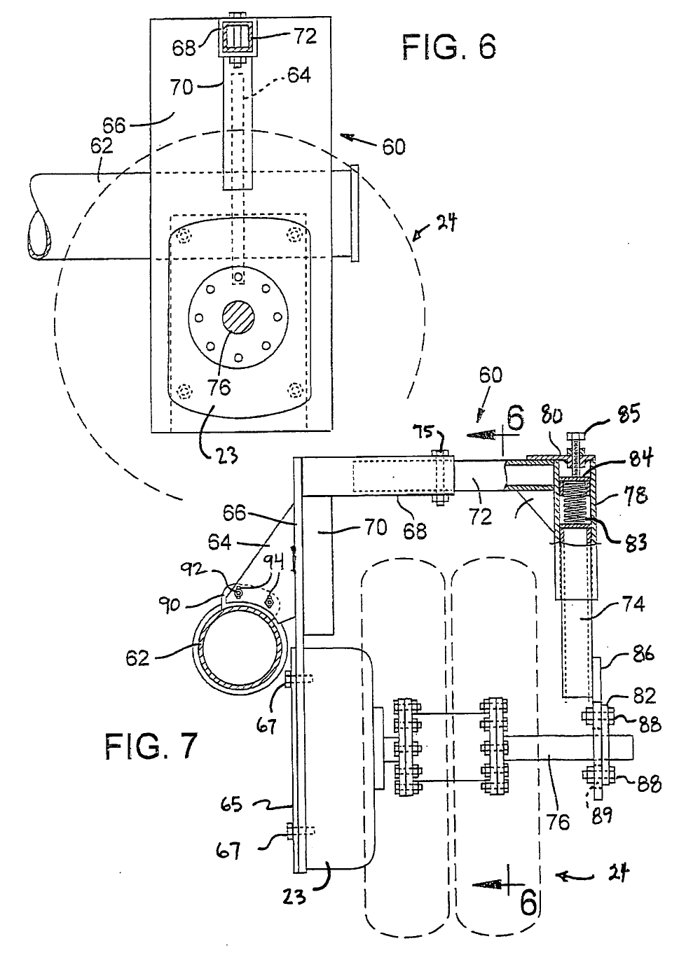

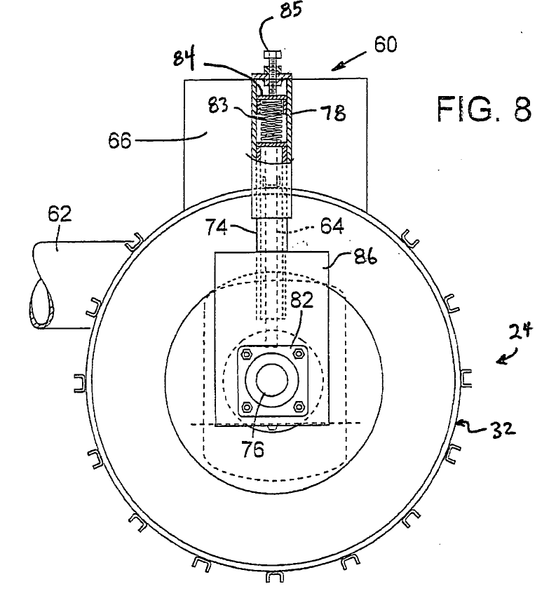

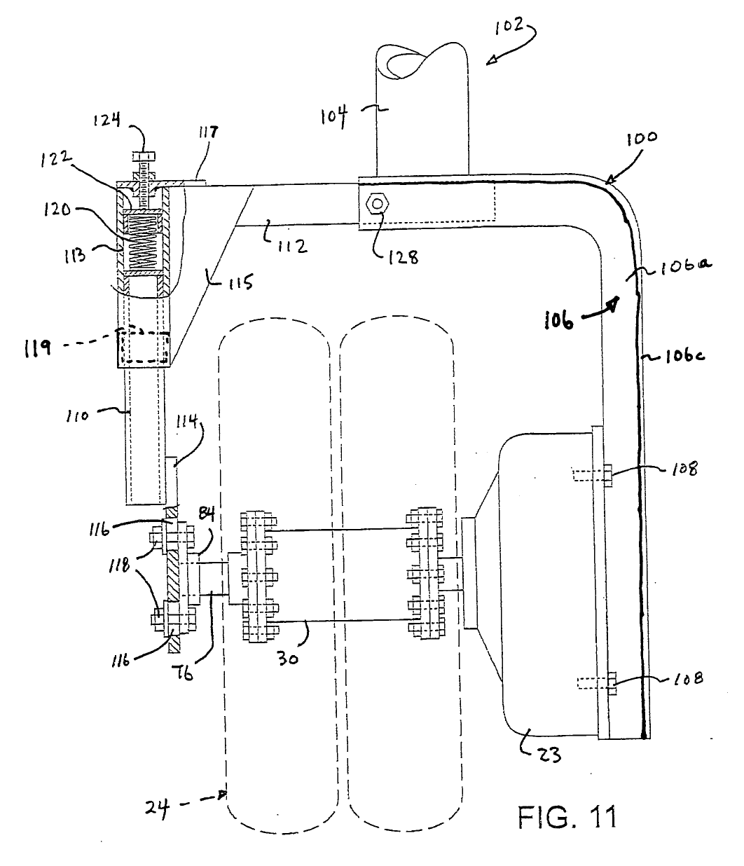

FIGS. 6-8 show a support frame 60 for tire assembly 24. Support frame 60 is removably connected to and supported by horizontal tube member 62 of tower 16 by a force transferring support plate 64. Support plate 64 may be welded or otherwise secured to an attachment plate 66 to which gear box 23 is secured through outer plate 65 by bolts or fasteners 67. Tire assembly 24 may be supported by horizontal support members 68 and 72 and a vertical support 74. Preferably, horizontal members 68 and 72 may have a telescoping connection and may be secured by a bolt 75 or other suitable fastener. This telescoping connection provides for horizontal adjustment of support frame 60 to accommodate various sizes of tires. In the embodiment shown in FIG. 7, member 68 telescopically receives member 72 and may be welded or otherwise secured substantially centrally to attachment plate 66. A strengthening element 70 may be welded or otherwise secured to both attachment plate 66 and member 68 to add support for member 68 and strength to plate 66. Vertical support 74 extends down from member 72 and may be connected thereto through an adjustable telescoping connection. Preferably, vertical support 74 may be telescopically received within a tube member 78 connected to member 72 through a plate 80 that may be welded or otherwise secured thereto. At least one and preferably two strengthening gussets 81 may be welded or otherwise fastened to secure tube member 78 and plate 80 to member 72. In order to provide further adjustment, a spring 83 extends between vertical support 74 and a bearing plate 84. An adjustment member such as, for example, a bolt 85 extends through a plate 80 and bears against bearing plate 84 to adjust the amount of force or pressure applied to the ground. Spring 83 provides that pressure is carried as evenly as possible on both sides of support frame 60. For example, on flat terrain pressure is distributed substantially evenly across support frame 60. However, if the terrain is uneven and is pitched higher on one side the pressure applied to that side of support frame is increased. Therefore, spring 83 substantially compensates for unevenness in the terrain and can be adjusted to match the terrain across which tire assembly 24 travels. Vertical support 74 supports an extended axle 76 of tire assembly 24 through plate 86. Plate 86 may be welded or otherwise secured to vertical support 74. A bearing 82 rotatably supports extended axle 76 and may be adjustably connected to plate 86 by bolts 88 or other suitable connectors extending through elongated bolt holes 89 in plate 86. This adjustability feature allows support frame 60 to be retrofit to a variety of tire assemblies 24. For simplicity, FIGS. 6 and 7 do not show belt 32 on tire assembly 24. However, it is understood that belt 32 may be used with tire assembly 24 in all embodiments of this invention.

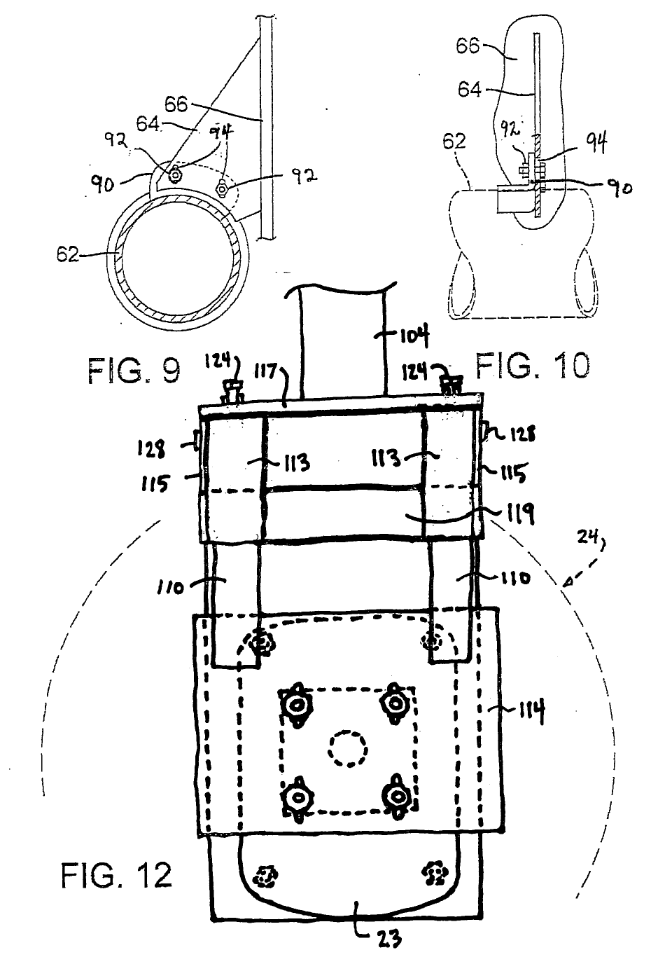

FIGS. 9 and 10 show a preferred adjustable connection between horizontal tube member 62 and support plate 64. A bracket or vertical plate 90 may be welded or otherwise secured to horizontal tube member 62. Support plate 64 may be removably connected to bracket 90 by bolts 92 or any other suitable fasteners extending through elongated holes 94 in support plate 64. Horizontal tube members 62 may vary in diameter. Elongated holes 94 provide adjustment so that support plate 64 may be connected to horizontal tube members 62 regardless of its diameter. Thus, as can be seen in FIGS. 6-10, support frame 60 substantially transfers forces to horizontal tube member 62 that would otherwise be applied to gear box 23 through tire assembly 24.

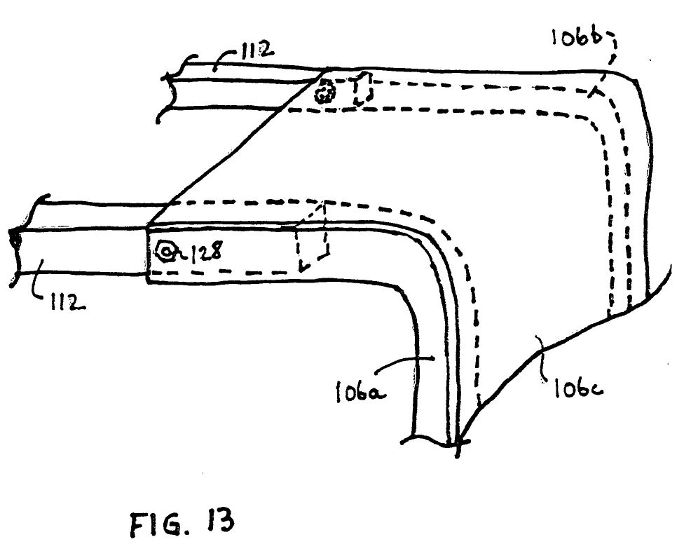

FIGS. 11-13 show another embodiment of this invention in which a support frame 100 is utilized in a corner sweep unit 102 of an irrigation system. Corner sweep unit 102 includes tire assembly 24 driven through gear box 23 as shown and described above. Corner sweep unit 102 may include a swivel support tube 104 that is telescopically received in a drive tube (not shown) so that corner sweep unit 102 rotates or is driven about swivel support tube 104 as is known in the art. Swivel support tube 104 may be connected to a frame assembly 106 that supports gear box 23 through bolts 108 or other suitable fastener. Frame assembly 106 may include opposed members 106a and 106b secured together preferably by welding to a connector plate 106c as seen most clearly in FIG. 13. For clarity, swivel support tube 104 has been omitted from FIG. 13. Tire assembly 24 is supported on the opposite side by opposed vertical members 110 and associated horizontal members 112. Tire assembly 24 may be connected to vertical members 110 through extended axle 76 rotatably supported by bearing 84. Bearing 84 may be adjustably connected to vertical members 110 through a plate 114 that extends between and may be welded or otherwise secured to vertical members 110. Plate 114 includes elongated holes 116 through which bolts 118 or other fasteners extend. This adjustability feature allows support frame 100 to be retrofit to a variety of tire assemblies. Vertical members 110 may preferably be connected to horizontal members 112 in a manner similar to that as shown and described in FIG. 7. More specifically, each vertical member 110 may be telescopically received in a female member 113 secured to a horizontal member 112 and strengthened by a gusset 115. A spring 120 may extend between vertical support 110 and a bearing plate 122. An adjustment member such as, for example, a bolt 124 may extend through plate 117 to bear against bearing plate 122 to adjust the amount of force or pressure applied to the ground. As described above, spring 120 provides that pressure is carried as evenly as possible on both sides of support frame 100 as the corner sweep unit 102 travels over uneven terrain. To strengthen and support vertical members 110, plate 117 extends between opposed vertical members 110 and opposed horizontal members 112 and may be welded or otherwise secured to vertical members 110 and horizontal members 112 as most clearly seen in FIG. 12. Additionally, a further strengthening member 119 is secured such as, for example, by welding between vertical members 110. Horizontal members 112 may be telescopically received in members 106a and 106b of frame assembly 106 and secured thereto by any suitable type of fastener 128. This telescopic connection allows for adjustment to accommodate tire assemblies of different widths.

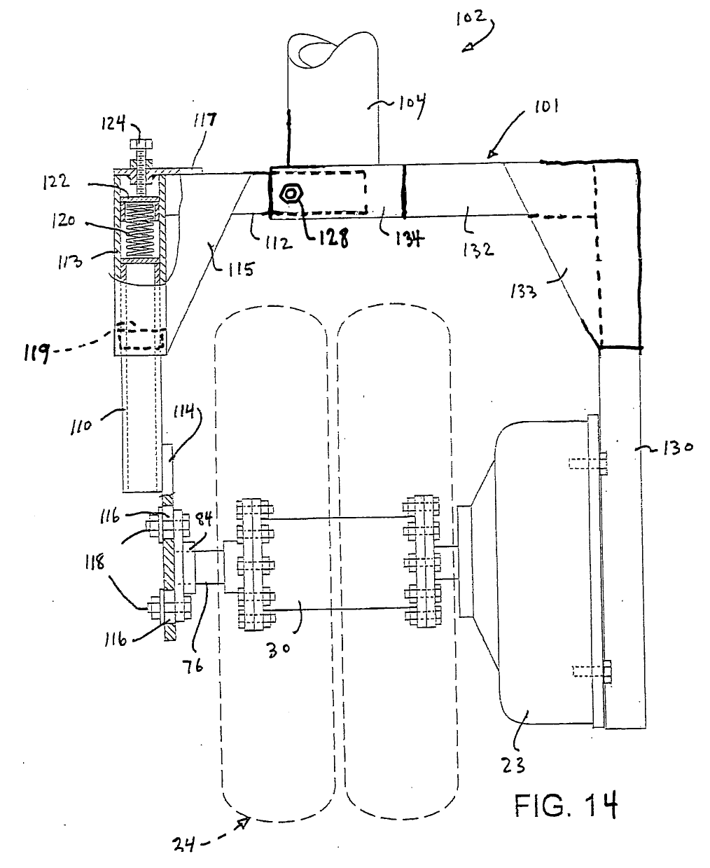

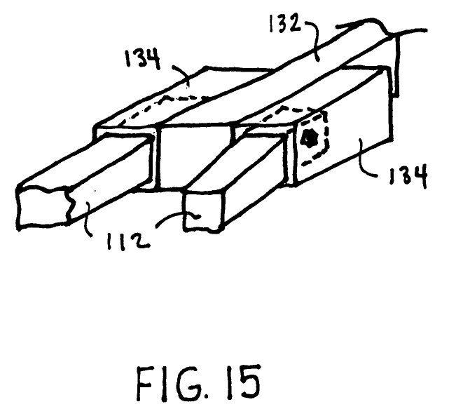

FIGS. 14 and 15 show an alternative support frame 101 in which gear box 23 is supported by a vertical member 130 and a horizontal member 132 welded or otherwise secured thereto and strengthened by at least one gusset 133. In this embodiment, horizontal members 112 may be telescopically received in opposed female members 134 that have been welded or otherwise secured to each side to horizontal member 132 as best seen in FIG. 15. For simplicity, swivel support tube 104 has been omitted from FIG. 15. Horizontal members 112 may be secured to associated members 134 by any suitable type of fastener 128. This telescopic connection allows for adjustment to accommodate tire assemblies of different widths. For simplicity, FIGS. 11-13 are shown with belt 32. However, it is understood that belt 32 may be used with tire assembly in these embodiments.

Persons skilled in the art will recognize that many modifications and variations are possible in the details, materials, and arrangements of the parts and actions which have been described and illustrated in order to explain the nature of this invention and that such modifications and variations do not depart from the spirit and scope of the teachings and claims contained therein.

What is claimed is:

1. A support frame for a tire assembly of a mobile irrigation system that includes a tower structure, comprising;
a first support member for supporting the tire assembly on one side,
a second support member for supporting a tire assembly on the opposite side and connected to the first support member, and
a force transfer member connected between the first support member and the tower structure for transferring forces generated by the tire assembly to the tower structure.

2. The support frame of claim 1, wherein the force transfer member is adjustably mounted to the tower structure.

3. The support frame of claim 1, wherein the first support member and the second support member are connected by a third support member.

4. The support frame of claim 3, wherein the third support member comprises an adjustable telescoping member.

5. The support frame of claim 1, further comprising an adjustable connection between the second support member and the tire assembly.

6. The support frame of claim 3, wherein the second support member is adjustably connected to the third support member.

7. The support frame of claim 6, further comprising a female member connected to the third support member that telescopically receives one end of the second support member.

8. The support frame of claim 7, further comprising a compensation spring located between the second support member and the female member to adjust to forces applied to the support frame caused by uneven terrain.

9. The support frame of claim 1, wherein the tire assembly comprises first and second tires mounted on an axle, and a flexible ground engaging member surrounding the first and second tires to provide a ground engaging surface to distribute the weight of the tower structure on the ground.

10. A tire assembly of a mobile irrigation system that includes a tower structure, comprising
first and second tires mounted on an axle, and a flexible ground engaging member surrounding the first and second tires to provide a ground engaging surface to distribute the weight of the tower structure on the ground,
a support frame for supporting the tire assembly, and
a force transfer member connected between the support frame and the tower structure for transferring forces generated by the tire assembly to the tower structure.

11. The tire assembly of claim 10, wherein the support frame comprises a first support member for supporting the tire assembly on one side and a second support member for supporting a tire assembly on the opposite side and connected to the first support member, wherein the force transfer member is connected between the first support member and the tower structure.

12. The tire assembly of claim 11, wherein the force transfer member is adjustably mounted to the tower structure.

13. The tire assembly of claim 11, wherein the first support member and the second support member are connected by a third support member.

14. The tire assembly of claim 13, wherein the third support member comprises an adjustable telescoping member.

15. The tire assembly of claim 11, further comprising an adjustable connection between the second support member and the tire assembly.

16. The tire assembly of claim 13, wherein the second support member is adjustably connected to the third support member.

17. The tire assembly of claim 13, further comprising a female member connected to the third support member that telescopically receives one end of the second support member.

18. The tire assembly of claim 17, further comprising a compensation spring located between the second support member and the female member to adjust to forces applied to the support frame caused by uneven terrain.

19. A corner sweeping unit for an irrigation system, comprising
a tire assembly including first and second tires mounted on an axle, and a flexible ground engaging member surrounding the first and second tires to provide a ground engaging surface to distribute the weight of the tower structure on the ground as the tire assembly is driven about a swivel support tube, and
a support frame for adjustably supporting the tire assembly.

20. The corner sweeping unit of claim 19, wherein the support frame comprises a first support member for supporting the tire assembly on one side, and a second support member for supporting a tire assembly on the opposite side thereof, the second support member being telescopically connected to the first support member to accommodate tire assemblies of varying widths.

21. The corner sweeping unit of claim 20, wherein the second support member is adjustably connected to the tire assembly.

22. The corner sweeping unit of claim 21, wherein the second support member includes male and female telescoping members.

23. The corner sweeping unit of claim 22, further comprising a compensation spring located between the male and female members to adjust to forces applied to the support frame caused by uneven terrain.

24. The corner sweeping unit of claim 23, further comprising an adjustment member for adjusting the force applied by compensation spring to the tire assembly.

25. The corner sweeping unit of claim 20, wherein the first support member is adjustably connected to the tire assembly.

26. The corner sweeping unit of claim 20, wherein the first support member includes male and female telescoping members.

27. The corner sweeping unit of claim 26, further comprising a compensation spring located between the male and female members to adjust to forces applied to the support frame caused by uneven terrain.

28. The corner sweeping unit of claim 27, further comprising an adjustment member for adjusting the force applied by compensation spring to the tire assembly.
